(19) United States
(12) Patent Application Publication
(10) Pub. No.: US 2011/0197801 A1
(43) Pub. Date: Aug. 18, 2011

(54) Sponge ballast system

(76) Inventor: Stanton Dennis Terrell, Falmouth, MA (US)

(21) Appl. No.: 12/932,022

(22) Filed: Feb. 16, 2011

Related U.S. Application Data
(60) Provisional application No. 61/338,349, filed on Feb. 18, 2010.

(51) Int. Cl. B63B 43/04; B23P 19/00; B63B 35/58

(52) U.S. Cl. 114/121; 29/428

(57) ABSTRACT

A floatation device of any size or shape stabilized by a ballast system comprised of sponge contained in permeable enclosures, which enclosures in turn are secured to the underside of the device, which sponge, upon contact with water, rapidly absorbs such water and provides prompt, sufficient ballast.

### CROSS-REFERENCE TO RELATED APPLICATIONS

This application claims the benefit of U.S. Provisional Application No. 61/338,349 filed by Stanton Dennis Terrell and Cynthia Mary Shell-Terrell and awarded a filing date of Feb. 18, 2010.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

The present invention relates generally to floatation devices and more specifically, as to certain embodiments, to stabilized rescue rafts.

Stabilized survival rafts are well known. For ballast, these rafts rely on a depending, weighted, water-enclosure system. These water-enclosure systems are designed in one of three ways: (one) several depending enclosures along the underside of a raft; (two) one large, depending enclosure under the center of a raft; or (three) several peripheral depending enclosures. These enclosures are sometimes referred to as “water-retaining chambers.” The several depending enclosures is seen in U.S. Pat. No. 3,092,854 issued Jul. 11, 1963, to Manhart; the large depending enclosure is seen in U.S. Pat. No. 4,001,905 issued Jan. 11, 1977, to Givens; and the several peripheral enclosures is seen in U.S. Pat. No. 4,216,559 issued Aug. 12, 1980, to Switlik. These systems remain in use today and represent the state of the art in stabilized survival rafts.

Rescue rafts differ from survival rafts in that they are generally smaller, allowing only one or two occupants, and provide fewer so-called survival supplies. A rescue raft is generally intended to prevent drowning or death from exposure while one awaits rescue, rather than providing for longer-term survival in open waters, as survival rafts are intended. Rescue rafts use either no ballast system or an ineffective, unweighted water-retaining chamber.

### BRIEF SUMMARY OF THE INVENTION

The present invention contemplates a floatation device. Ballast is provided by compressed sponge within one or more permeable enclosures attached securely to the underside of the device or to the periphery of the device or both. The permeable enclosures need only (one) allow for rapid entry of fluid, usually water; (two) allow for the expansion of compressed sponge; and (three) provide continued containment of the saturated sponge. The enclosures could be sturdy, with perforation; flexible, with perforation; mesh; or any permeable enclosure capable of allowing sufficient fluid entry, capable of containing compressed and then expanded sponge, and capable of being secured to the underside of a floatation device.

Once the compressed sponge expands from absorption, the ballast provided allows one easily to mount the floatation device without the difficulty typically encountered when one attempts to mount a non-stabilized floatation device, that is, that the opposite side of the device rises, hampering or preventing entry upon the device. Unlike floatation devices fitted with water-retaining chambers, the present invention provides ballast almost immediately upon deployment in water; significantly reduces the risk that a floatation device will overturn due to wind, wave, or both; and provides ballast without the additional weight ordinarily required to depend water-retaining chambers.

Other unique features of the present invention will become apparent upon reading the following specification.

### BRIEF DESCRIPTION OF THE DRAWINGS

FIG. 1 is a bottom view of a conventional two-person raft showing a suitable placement of the sponge ballast system.

FIG. 2 is a bottom view of a conventional two-person raft showing the placement of several sponge elements within permeable enclosures.

FIG. 3 is a front-side view of a conventional two-person raft suggesting the permeable enclosures with enclosed sponge elements.

### DETAILED DESCRIPTION OF THE INVENTION

The invention includes any floatation device for which ballast is provided by sponge, usually but not necessarily compressed synthetic sponge, contained in one or more permeable enclosures, which enclosures in turn are secured to the underside of the device. As used in this application, “floatation device” or “floatation element” refers to any item capable of providing buoyancy, such as, for instance, inflated synthetic rubber.

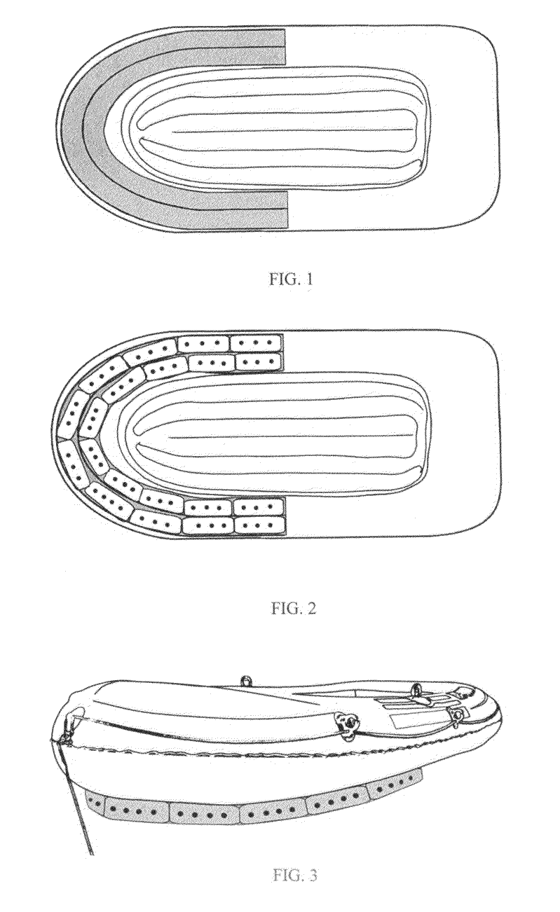

Referring now to the drawings, FIG. 1 illustrates a suitable placement of permeable enclosures, said enclosures indicated with shading, said enclosures being secured to the underside of a floatation device. FIG. 2 illustrates the placement of sponge within the permeable enclosures, said sponge indicated by several dots within a rounded rectangular shape. The number of dots is not significant. FIG. 2 indicates generally how the permeable enclosures might be segmented so that each sponge element is separately contained within a separate permeable enclosure. FIG. 3 suggests permeable enclosures with enclosed sponge, as might appear on an inflated two-person raft. FIG. 3 also indicates generally how the permeable enclosures might be segmented so that each sponge element is separately contained within a separate permeable enclosure.

The sponge ballast system need not be configured as indicated and may be configured in any fashion along the underside or periphery of a floatation device.

The sponge ballast system can be configured to provide ballast of any desired significance by using larger sponge and correspondingly larger permeable enclosures, adding permeable enclosures, stacking permeable enclosures, or any other configurations providing a greater volume of sponge.

The invention may be configured in the shape of a traditional, circular, life preserver or life ring, yet with a floor rather than a middle opening, and configured with the sponge ballast system, allowing one to avoid exposure to water while awaiting rescue.

The invention need not be configured for human occupancy and could be configured, for instance, for use as a transport device over any water, such as might occur, for instance, if one sought to transport items while wading across a river.

A contemplated embodiment of the invention employs compressed cellulose sponge contained in perforated Neoprene synthetic rubber, heat sealed along the inflatable element of a traditional two-person raft with inflatable floor ad depicted in FIG. 3. The permeable enclosures are configured in segments to allow easy folding and packing. The raft is packaged compactly for storage on or in kayaks, canoes, small boats, or small-engine aircraft. This embodiment may be packed with a rope ladder and traditional survival items and in such a fashion as to inflate in an upright position and is suitable for use in costal waters.

In certain embodiments, the permeable enclosures could be accessible, allowing removal of saturated sponge, with or without replacement of the saturated sponge with dry sponge.

No attempt is made to illustrate the means of manufacture and securing such ballast system, particularly the permeable enclosures, as this is thought sufficiently obvious as not to require special illustration.

No attempt is made to illustrate the means for inflating a floatation device, as this is thought sufficiently obvious as not to require special illustration.

Finally, it will be understood that various embodiments have been disclosed by way of example, and that other modifications may occur to those skilled in the art without departing from the scope and spirit of the appended claims.

What is claimed is:

1. A floatation device comprising:
a floatation element of any size or shape;
one or more permeable enclosures secured to the underside or periphery of said floatation element in which enclosures sponge is contained;
said permeable enclosures configured to allow rapid entry of fluid and expansion of the contained sponge while continuing to contain the saturated sponge.

2. A floatation device comprising:
a floatation element of any size or shape;
a floor joined at its periphery to said element and made stable by such floatation element;
one or more permeable enclosures secured to the underside or periphery of said floatation device in which enclosures sponge is contained;
said permeable enclosures configured to allow rapid entry of fluid and expansion of the contained sponge while continuing to contain the saturated sponge.

3. The floatation device of claim 2, wherein said floatation element is formed of a single enclosure of heavy duty synthetic rubber joined at its ends with resulting dimensions of approximately 7 feet long, 4 feet wide, and 18 inches high, and wherein said permeable enclosures are formed of perforated synthetic rubber, and wherein the sponge enclosed in said permeable enclosures is compressed cellulose sponge.

4. The floatation device of claim 3, wherein said floor is an inflatable floor.

5. The floatation device of claim 3 or claim 4, wherein said permeable enclosures are configured in such a way as to allow compact folding of the device.

6. The floatation device of claim 2, wherein said floatation element is formed of a single enclosure of heavy duty synthetic rubber joined at its ends with a resulting circular dimension, wherein the floor joined to said element has a diameter of approximately four feet and wherein said floor is an inflatable floor.

7. A method of providing ballast, said method comprising the steps of: containing sponge in permeable enclosures and attaching said enclosures to the underside of a floatation device.
